(19) United States
(12) Patent Application Publication
(10) Pub. No.: US 2011/0320272 A1
(43) Pub. Date: Dec. 29, 2011

(54) System and Method for Advertisement of Brand Specific Content on a Media Player Graphical User Interface

(75) Inventors: Chhavi Upadhyay, Sanata Clara, CA (US); Venkata Srikanth Kakani, Santa Clara, CA (US); Saurabh Bhatia, New Delhi (IN)

(73) Assignee: Vdopia, INC.

(21) Appl. No.: 12/468,895

(22) Filed: May 20, 2009

Related U.S. Application Data
(60) Provisional application No. 61/128,309, filed on May 21, 2008.

(51) Int. Cl. G06Q 30/00

(52) U.S. Cl. 705/14.49; 705/14.69; 705/14.73

(57) ABSTRACT

A system and method for customizing a media player graphical user interface integrated to a website for advertising one or more brand-specific content along with the streaming digital media content provided by the website. The system and method includes dynamically incorporating brand specific content into the media player graphic user interface. The appearance of the media player changing according to the predefined advertiser's preference.

### BACKGROUND OF THE INVENTION

1. Field of the Invention

The present invention relates to a system and method for advertisement of brand specific content on graphical user interface of a media player. More specifically, the present invention aims at customizing a media player graphical user interface integrated to a website for advertising one or more brand-specific content along with the streaming digital media content provided by the website.

2. Description of the Prior Art

Internet has changed the way we access information today. Recently, the websites related to music, video and news have started providing audio/video streaming functionalities on their websites. The fast data transmission techniques made this feasible. The streaming video has taken the world by storm. The news sites are not left alone they have also started providing streaming video of the breaking news. These changes increased the number of visits to these websites. Subsequently, it has become a smart way to advertise and cover a large user base.

Presently, most of the Websites realized the potential of earning by selling advertising spaces on their WebPages. Such advertising space usually comprises tickers, banner, static images and logos of the advertisers. This type of advertisement is useful when a user is going through the text or article published on the website. But with the life becoming hectic and people showing less interest in spending time on reading and preferring to watch or listen the website content rather than reading it. After realizing this, most of the websites started providing streaming multimedia content services along with conventional text content on their websites. So most of the websites have started having an integrated media player on their WebPages for displaying multimedia content by streaming digital media content. The users have found this a better way to go through the content of website and started spending more time watching the content on media players. This made it necessary to advertise on the media player for getting greater user attention. Presently, there are some methods being used for displaying advertisement on media player. The methods include inserting banners, tickers and logos or trademarks of the advertisers into the interface of the media players.

Moreover, as most of the methods do not allow the advertiser to assign a preference for changing the appearance of the media player while displaying the advertisement of their interest on the media player. Further, the methods do not provide more than one advertisement campaign plan to be shown to different end users. This leads to choosing an advertisement campaign plan which is not suitable to the need of the advertiser. Meaning that these methods do not allow the advertiser to show different graphical user interface of the media player to different users. Making the current methods incapable of targeting users based on targeting criteria including but not limited to geography, demography, site, behavioural, contextual, keyword targeting

Further, the advertisers are billed on the basis of a package deal. This makes the advertiser pay unjustifiable amount even if the advertisement did not result the desired marketing leverage. For example, the advertiser is billed on the basis of number of views. In addition, the existing advertising methods do not allow changing the advertisement content dynamically whenever the media player is initiated.

Further more, the present advertisements methods do not allow incorporation of animated advertisement content in the media player graphical user interface.

In the light of the foregoing discussion, there is a need for a system and method for customizing a media player graphical user interface integrated to a website for advertising one or more brand-specific content along with the streaming digital media content provided by the website. Further, there is a need for a system and method for assigning advertiser's preferences for changing the appearance of the media player while displaying the advertisement of his interest on the media player. Further, there is a need for a system and method for providing more than one advertisement campaign plan which can be selectable by the advertiser according to his targeting requirements. Additionally, there is a need for a system and method which can provide a justifiable billing mechanism for calculating bill not only considering the number of views of the advertisement. Further, there is a need for a system and method for changing the advertisement content dynamically at every instance when the media player is initiated. Still further, there is a need for a system and method for incorporating animated advertisement content in the media player graphical user interface.

### SUMMARY OF THE INVENTION

Accordingly, it is an object of the present invention to provide a system and method for customizing a media player graphical user interface integrated to a website for advertising one or more brand-specific content along with the streaming digital media content provided by the website.

It is another object of the present invention to provide a system and method for assigning advertiser's preference for changing the appearance of the media player while displaying the advertisement of his interest on the media player.

It is yet another object of the present invention to provide a system and method for providing more than one advertisement campaign plan which can be selectable by the advertiser according to his requirement, allowing advertiser to target different campaign plans to different users based on advertiser preference

It is yet another object of the present invention to provide a system and method which can provide a justifiable billing mechanism for calculating bill not only considering the number of views of the advertisement.

It is still another object of the present invention to provide a system and method for changing the advertisement content dynamically at every instance when the media player is initiated.

It is still yet another object of the present invention to provide a system and method for incorporating animated advertisement content in the media player graphical user interface.

The above and other objects of the present invention are achieved by providing a system and method for customizing a media player graphical user interface integrated to a website for advertising one or more brand-specific content system. The system includes an advertisement campaign management module, the advertisement campaign management module comprises of an upload module, a brand specific content storage module, and advertisement campaign plan selector module, brand specific content incorporation module and a billing module. An interested advertiser uploads brand-specific content using upload module. The uploaded brand-specific content is stored in the brand-specific content storage module. The interested advertiser selects the available advertising campaign plan using an advertisement campaign plan selector module. A brand specific content incorporation module incorporates a brand specific content into the media player interface for display of the brand specific content on the media player interface. A media player graphical user interface comprises a digital media streaming module and a brand specific content display module. The digital media streaming module streams the digital media provided by the website. Meanwhile the brand specific content incorporation module incorporates a brand specific content and the brand specific content display module displays one or more brand specific content on the media player graphical user interface.

The present invention provides a system which is able to provide a customizable media player graphical user interface integrated to a website for advertising one or more animated or non-static brand-specific content. Further, the method for customizing media player graphical user interface integrated to a website facilitates advertising one or more animated or non-static brand-specific content on the media player graphical user interface. Moreover, the appearance of the media player can be changed according to the advertiser's preference. Additionally, the advertiser can advertise one or more brand specific content on one or more website having integrated media player.

### BRIEF DESCRIPTION OF THE DRAWINGS

For a more complete understanding of the present invention, the needs satisfied thereby, and the objects, features, and advantages thereof, reference now is made to the following description taken in connection with the accompanying drawings.

FIG. 1 illustrates an environment in which various embodiments of the invention can be practised.

FIG. 2 illustrates an advertisement campaign management module, in accordance with another embodiment of the invention.

FIG. 3 illustrates a media player graphical user interface module, in accordance with an embodiment of the invention.

FIG. 4 is a flowchart illustrating exemplary processing steps for customizing a media player graphical user interface integrated to a website for advertising one or more brand-specific content along with the streaming digital media content provided by the website, in accordance with an embodiment of the present invention.

FIG. 5 illustrates an exemplary media player graphical user interface displaying the brand specific content, in accordance with an embodiment of the present invention.

FIG. 6 illustrates an exemplary media player graphical user interface displaying the brand specific content and brand specific content acting as a hyper-link on click action, in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail the particular system and method for customizing a media player graphical user interface integrated to a website for advertising one or more brand-specific content along with the streaming digital media content provided by the website in accordance with an embodiment of the present invention. It should be observed that the present invention resides primarily in combinations of system components related to customizing a media player graphical user interface of the present invention.

Accordingly, the system components have been represented where appropriate by conventional symbols in the drawings, showing only those specific details that are pertinent to understanding the present invention so as not to obscure the disclosure with details that will be readily apparent to those of ordinary skill in the art having the benefit of the description herein.

In this document, relational terms such as ‘first’ and ‘second’, and the like may be used solely to distinguish one entity or action from another entity or action without necessarily requiring or implying any actual such relationship or order between such entities or actions. The terms ‘comprises’, ‘comprising’, or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by ‘comprises . . . a’ does not, without more constraints, preclude the existence of additional identical elements in the process, method, article, or apparatus that comprises the element.

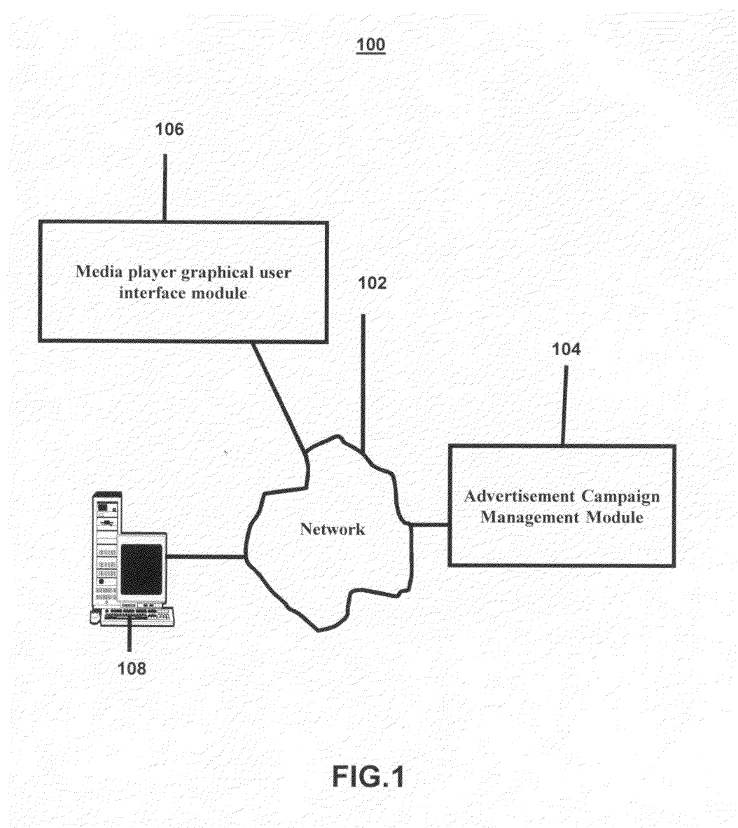

FIG. 1 illustrates an environment 100 in which various embodiments of the invention may be practised. Environment 100 includes the system 108, one or more computing devices, hereinafter collectively referred to as the computing device 108, a network 102, an Advertising campaign management module 104, and a Media player graphical user interface module 106. The Advertising campaign management module 104, and the Media player graphical user interface module 106, are connected to the computing device 108 through the Network 102. Examples of the network 102 include, but are not limited to, at least one of internet, intranet, Local Area Network (LAN), and Virtual Private network (VPN).

According to one of the embodiments of the present invention, the network 102 is a conglomeration of connected intranets.

According to another embodiment of the present invention, the network 102 is IPV6 compatible internet.

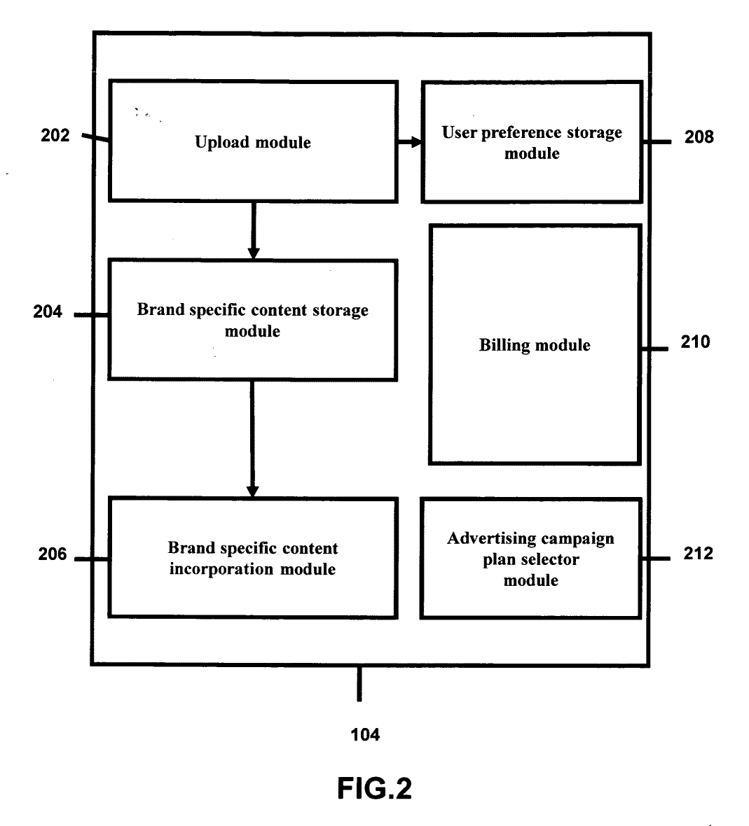

FIG. 2 illustrates advertisement campaign management module 104, in accordance with an embodiment of the invention. The advertisement campaign management module 104 includes one or more modules, where the one or more modules include an Upload module 202, a Brand specific content storage module 204, a Brand specific content incorporation module 206, a user preference storage module 208, a Billing module 210 and an advertising campaign plan selector module 212. The Upload module 202 facilitates the uploading of brand specific content in a predefined format. The examples of the predefined format include, but not limited to text, logos, images, .gif, .swf and other media files. In an embodiment, an interested advertiser performs uploading of the brand specific text, logos, images, .gif, .swf and other media files only after signing up with a registered user ID and password. Brand specific content storage module 206 is capable of storing the uploaded brand specific text, logos, images, .gif, .swf and other media files. Brand specific content incorporation module 206 includes selection and incorporation of the brand specific content into the media player graphical user interface. The Brand specific content incorporation module 206 also has the capability of dynamically selecting and incorporating brand specific content into the media player graphical user interface. The user preference storage module 208, allows the storage of the preferences of the advertiser. The example of the preferences include, but not limited to changing skin of the media player, animation schemes for advertising the brand specific content, color schemes for the media player and the like.

In accordance with an embodiment of the invention, the advertisement campaign management module 104, includes a skin color change module for automatically changing the color of skin of the media player according to the advertiser preference stored in user preference storage module 208.

The billing module 210, allows the calculation of bill based on the time period for which the brand specific content got displayed into a media player graphical user interface. This allows an advertiser for a time based display of the brand specific content rather than the number of views. The advertising campaign plan selector module 212, allows the advertiser to select various advertising campaign plans based on various targeting parameters. The advertising campaign plan selector 212, allows the advertiser to choose the advertisement campaign plan according to his requirements.

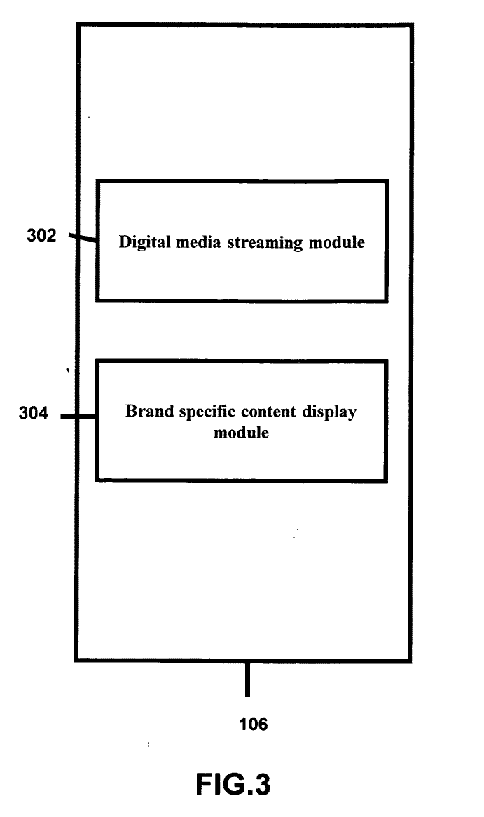

FIG. 3 illustrates a media player graphical user interface 106, in accordance with an embodiment of the invention. The media player graphical user interface 106 includes a digital media streaming module 302 and a brand specific content display module 304. The digital media streaming module 302, includes, but not limited to streaming video, audio or digital media from a website having an integrated media player graphical user interface. The brand specific content display module 304 allows display of the brand specific content stored in the Brand specific content storage module 204 and incorporated in the media player graphical user interface 106 by the Brand specific content incorporation module 206.

In accordance with an embodiment of the invention, the brand specific content incorporated in the media player graphical user interface 106 acts as hyperlink on performing a click action.

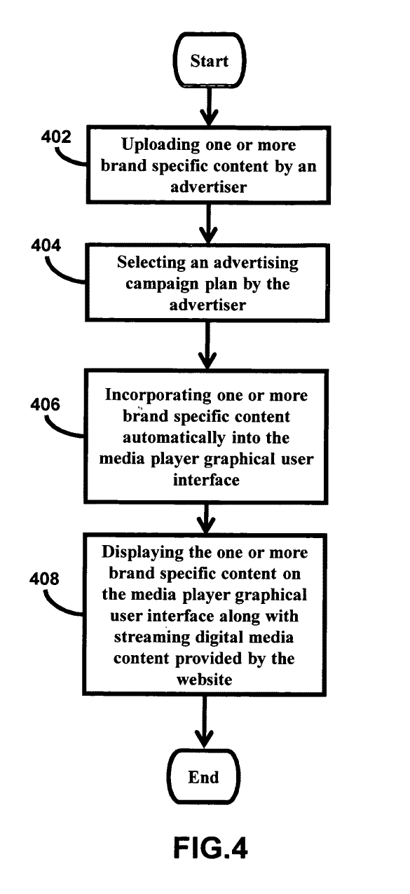

FIG. 4 is flowchart illustrating exemplary processing steps for customizing a media player graphical user interface integrated to a website for advertising one or more brand-specific content along with the streaming digital media content provided by the website, in accordance with an embodiment of the present invention. At step 402, the advertiser uploads one or more brand specific content by the advertiser. Example of the one or more brand specific content includes, but not limited to an animated image, text, a Flash® file, text, logos, images, .gif, .swf and other media files or the like. At step 404, the advertiser selects an advertisement campaign plan. The advertising campaign plan selected by the advertiser on the basis of various targeting parameters. At step 406, a brand specific content is automatically incorporated into the media player graphic user interface. The brand specific content is dynamically incorporated into the media graphic user interface at every instance of initiation of the media player. Further, the appearance and color of the media player gets changed according to the user preference at every instance of initiation of the media player. At step 408, the brand specific content is displayed on the media graphic user interface along with streaming digital media content provided by the website.

In accordance to an embodiment of the invention, the streaming of digital media content can be media playback via progressive download.

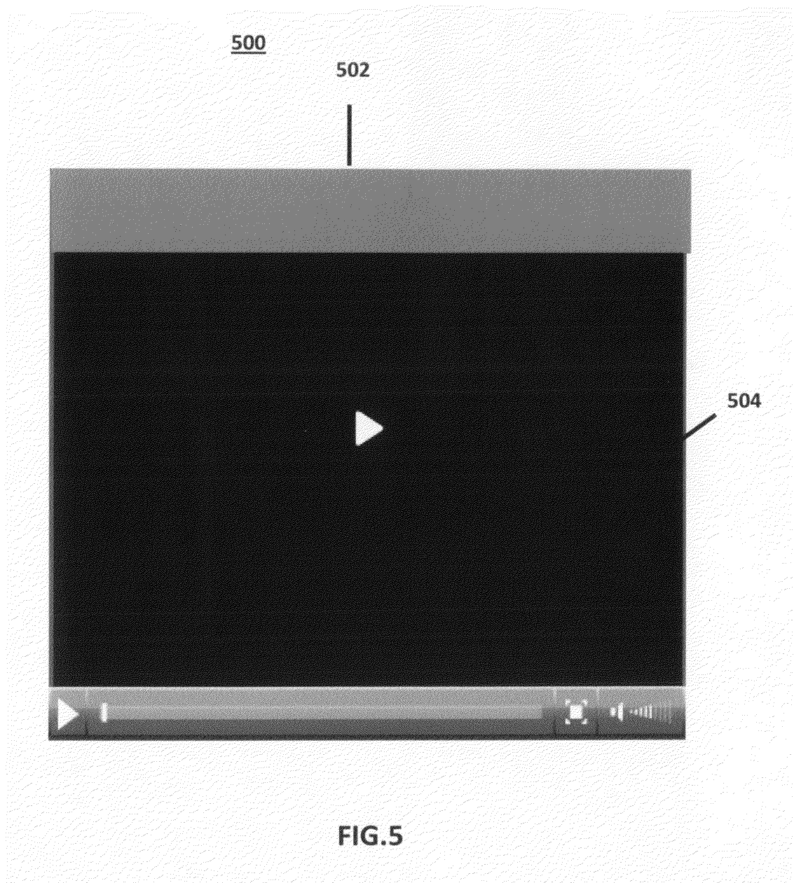

FIG. 5 illustrates an exemplary interface of the media player displaying the brand specific content, in accordance with an embodiment of the present invention. The media player graphical user interface 500 have a brand specific content advertising space 502 and a digital media streaming content display space 504. The brand-specific content displayed in the brand specific content advertising space 502. Example of the brand specific content includes, but not limited to an animated image, text, a Flash® file, text, logos, images, .gif, .swf and other media files or the like. Further, the color of the media player graphical user interface can be changed according to the advertiser's preference.

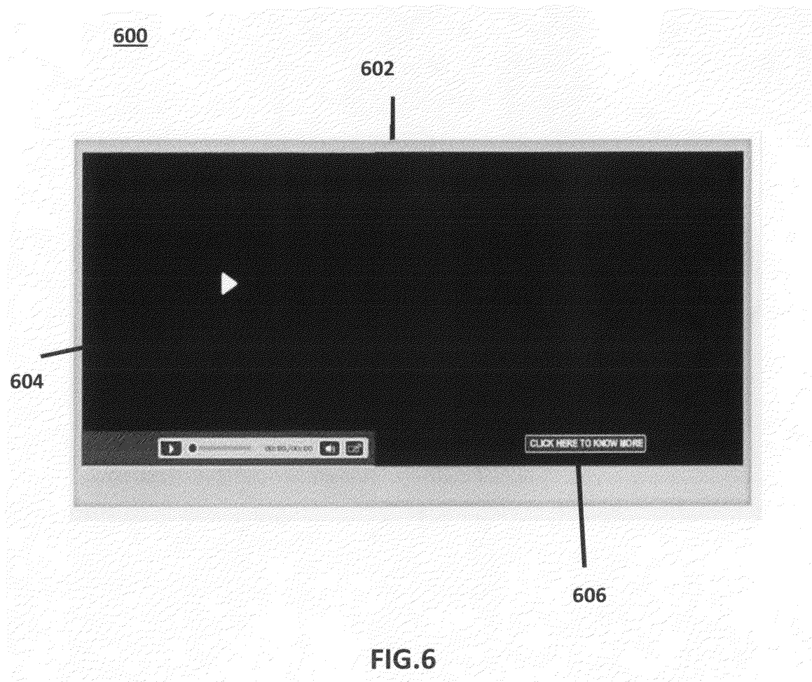

FIG. 6 illustrates an exemplary interface of the media player displaying the brand specific content, in accordance with an embodiment of the present invention. The media player graphical user interface 600 have a brand specific content advertising space 602 and a digital media streaming content display space 604. The brand-specific content displayed in the brand specific content advertising space 602. Example of the brand specific content includes, but not limited to an animated image, text, a Flash® file, text, logos, images, .gif, .swf and other media files or the like. Further, brand specific contents acting as one or more hyperlink on performing click action 606.

The present invention provides a system and method which is able to customize a media player graphical user interface integrated to a website for advertising one or more brand-specific content along with the streaming digital media content provided by the website. The brand specific content is being dynamically changed at every instance of initiation of the media player. Further, the brand specific content automatically incorporated in the media player graphical user interface without any manual intervention. Moreover, the advertiser can store his preferences for the appearance and color scheme of the media player. Additionally, the advertisement is billed on the basis of the time period for which the brand specific content was displayed on the media player graphical user interface.

While the present invention has been described in connection with preferred embodiments, it will be understood by those skilled in the art that variations and modifications of the preferred embodiments described above may be made without departing from the scope of the invention. Other embodiments will be apparent to those skilled in the art from a consideration of the specification or from a practice of the invention disclosed herein. It is intended that the specification and the described examples are considered exemplary only, with the true scope of the invention indicated by the following claims.

What is claimed is:

1. A system for customizing a media player graphical user interface integrated to a website for advertising one or more brand-specific content along with the streaming digital media content provided by the website, the system comprising:
a) an advertisement campaign management module, the advertisement campaign management module comprising:
i. an upload module, the upload module uploading the one or more brand-specific content;
ii. a brand-specific content storage module, the brand-specific content storage module storing the one or more brand-specific content;
iii. an advertising campaign plan selector module, the advertising campaign plan selector module selecting an advertising campaign plan;
iv. a brand specific content incorporation module, the brand specific content incorporation module incorporating the one or more brand specific content into the media player interface; and
v. a billing module, the billing module performing the billing on the basis of the total minutes of display of the one or more brand specific content on the website.
b) a media player graphical user interface module, the media player graphical user interface module comprising:
i. a digital media streaming module, the digital media streaming module streaming the digital media; and
ii. a brand specific content display module, the brand specific content display module displaying the one or more brand specific content.

2. The system as recited in claim 1, wherein the advertisement campaign management module comprises a skin color change module for automatically changing the color of skin of the media player according to the advertiser preference.

3. The system as recited in claim 1, wherein the one or more brand specific content comprises an animated image, text, a Flash® file or the like.

4. The system as recited in claim 1, wherein the upload module allowing uploading of the one or more brand specific content in a predefined format.

5. The system as recited in claim 1, wherein the advertising campaign plan selector module provides various options to the advertiser for selecting the advertising campaign plan based on various targeting parameters.

6. The system as recited in claim 1, wherein the brand specific content incorporation module dynamically incorporates the one or more brand specific content at every instance of initiation of the media player.

7. The system as recited in claim 1, wherein the one or more brand specific contents acting as one or more hyperlink on performing click action/mouse movement action or any other mouse or keyboard action.

8. The system as recited in claim 1, wherein the digital media streaming includes media playback via progressive download.

9. A method for customizing a media player graphical user interface integrated to a website for advertising brand-specific content along with the streaming digital media content provided by the website, the method comprising:
a) uploading one or more brand specific content by an advertiser;
b) selecting an advertising campaign plan by the advertiser;
c) incorporating one or more brand specific content automatically into the media player graphical user interface; and
d) displaying one or more brand specific content on the media player graphical user interface along with streaming digital media content provided by the website.

10. The method as recited in claim 9, wherein the customizing the media player graphical user interface further comprises changing the color of skin of the media player according to the advertiser preference.

11. The method as recited in claim 9, wherein uploading the one or more brand specific content by an advertiser further comprises uploading an animated image, text, a Flash® file or the like.

12. The method as recited in claim 9, wherein the advertising campaign plan being selected by the advertiser on the basis of various targeting parameters.

13. The method as recited in claim 9, wherein the one or more brand specific contents being dynamically incorporated into the media player graphical user interface on every instance of initiation of the media player.

14. The method as recited in claim 9, wherein the one or more brand specific contents acting as a hyperlink on performing a click action/mouse movement action or any other mouse or keyboard action.

15. The method as recited in claim 9, wherein the website includes a downloadable media player software application for streaming digital media content provided by the website.

16. The method as recited in claim 9, wherein streaming digital media includes media playback via progressive download.
